(19) United States
(12) Patent Application Publication
(10) Pub. No.: US 2010/0098489 A1
(43) Pub. Date: Apr. 22, 2010

(54) PREFORMED SCREED SYSTEM

(76) Inventor: Robert W. Pollack, Chappaqua, NY (US)

Correspondence Address: EDWARDS ANGELL PALMER & DODGE LLP, P.O. BOX 55874, BOSTON, MA, 02205, US

(21) Appl. No.: 12/582,748

(22) Filed: Oct. 21, 2009

Related U.S. Application Data
(60) Provisional application No. 61/107,337, filed on Oct. 21, 2008.

(51) Int. Cl. E01C 19/22; B23P 17/00

(52) U.S. Cl. 404/118; 29/527.1

(57) ABSTRACT

The present disclosure relates to a system comprising preformed screed elements, which can be made of any suitable material, but is particularly adapted to being formed from a cementitious material. Alternative materials from which the screed elements can be formed include plastic, ceramic, clay and composite materials, such as fiber-reinforced materials. Advantageously, the screed elements of the system can be formed from a recycled material including but not limited to recycled glass, polypropylene, recycled aggregate in a cementitious matrix, asphalt-based materials or any other suitable durable material.

### CROSS REFERENCE TO RELATED APPLICATION

This present application claims benefit of priority from U.S. Provisional Patent Application Ser. No. 61/107,337, filed Oct. 21, 2008. The disclosure of the aforementioned patent application is incorporated by reference herein in its entirety.

### BACKGROUND

1. Field of the Invention

The present invention is related to the field of construction, and particularly to construction products. More specifically, the present invention is directed to a system and element thereof for use with poured concrete surfaces.

2. Description of Related Art

Wooden formwork comprised of boards staked into the ground is commonly used for poured-in-place concrete surfaces for containing a volume to be filled with concrete. Upper edges of the wooden formwork are typically used as guides for a screed passed over the surface of the poured concrete to smooth and level the surface thereof.

### SUMMARY OF THE DISCLOSURE

The present disclosure relates to a system comprising preformed screed elements, which can be made of any suitable material, but is particularly adapted to being formed from a cementitious material. Alternative materials from which the screed elements can be formed include plastic, ceramic, clay and composite materials, such as fiber-reinforced materials. Advantageously, the screed elements of the system can be formed from a recycled material including but not limited to recycled glass, polypropylene, polyethylene terephthalate (“PET”), recycled aggregate in a cementitious matrix, asphalt-based materials or any other suitable durable material.

In accordance with a preferred aspect of the invention, the subject screed elements have a decorative appearance, which can include a real or imitation brick surface, a real or imitation stone surface, a real or imitation tile surface, exposed aggregate or other aesthetically desirable material in any desired color or in any desired pattern.

The subject devices and systems facilitate the placement and leveling of surfaces paved with concrete including but not limited to sidewalks, roads, driveways and other vehicle paths, patios, plazas and the like. In accordance with a preferred aspect, the subject screed elements are formed of a colored material, such as colored concrete, for example, and embossed to replicate brick, stone, tile or other desired surface.

In accordance with one aspect of the invention, the screed elements of the subject system are formed of an elongated pre-cast concrete strip. In accordance with the invention, the screed elements are formed in lengths that can be safely carried and placed by one or two adult workers. A carrying aid can be employed to facilitate placement of the screed elements.

The height of the screed elements can be selected to be about the same thickness as the desired depth of concrete surface to be poured. In accordance with one embodiment of the invention, the height of the screed elements can be between about 2 inches (5 cm) and 12 inches (30 cm). A range of heights of screed elements can also be provided for example, the subject screed elements can be provided at any one or plurality of heights between about 2 inches (5 cm) and 12 inches (30 cm), at any 1 inch (2.5 cm) increment therebetween. If used for vehicle pathways, such as a driveway a greater height such as six or eight inches may be desirable as the required thickness for roadways is typically greater than for sidewalks and other such areas.

In accordance with one aspect of the invention, installation of the subject system includes preparation of the substrate (e.g., the ground in the area of installation), as is customarily done. The installation of any subsurface piping, conduits and the like, if required for drainage, or preparations for other functions can be made at that time. Then, the layout of the proposed paved area is typically staked-out. A gravel or other porous base as appropriate would be distributed, rolled and compacted as required. In accordance with the invention, the porous base is preferably laid slightly larger than the proposed paved area, taking into account the area occupied by the screed elements, so as to provide adequate support therefor.

Following installation of a base layer, the screed elements can be installed to form stops for all sides of the proposed poured concrete area. Metal or wooden stakes can be driven beside or through designated apertures in the screed elements to provide additional anchorage therefor, to inhibit undesired movement thereof prior to curing of the concrete. The screed elements can be arranged end-to-end to extend the length of the screed system, and installed end-to-side to extend a width of the screed system.

Screed elements can be pinned and/or tied together to achieve facilitate alignment and stability of the system—that is an array of the subject screed elements arranged in the desired configuration to form the desired concrete area. Screed elements can also be provided in straight segments, curved segments, “L”-shaped corner segments and cross-shaped segments, as desired.

If reinforcement is required, mesh can be laid down prior to or during pouring of the concrete matrix. Alternatively or additionally, a fiber-reinforced concrete can be used, if desired. Reinforcing bars can be installed continuously from poured panel to poured panel by inserting such reinforcing bars through holes provided in a web of the screed elements.

After the concrete is poured, consolidated, and leveled with a screed board or other like device, it can then be finished, textured and/or treated with another surface treatment. Unlike traditional devices and methods, the screed elements are not removed from the poured slab, but remain in place and serve as decorative elements. The surface(s) of the screed elements that remain exposed after pouring of the concrete, can be protected from staining and/or blemishing during placement and pouring of concrete by way of a removable protective coating or cover applied thereto, which can inhibit bonding with concrete in that area, such as a sealer or wax, and/or can be removable after pouring, such as a removable paper or plastic strip.

The concrete can be tooled, stained, embossed or provided with other treatment prior to curing, as with traditional concrete surfaces. Such surface treatments can include Bomanite® treatments for concrete finishes—a proprietary system of concrete finishing available from Bomanite Corporation of Madera, Calif. USA.

In accordance with a preferred aspect, the screed elements are formed from a molded or extruded colored concrete. In manufacture, if extruded, the screed elements can be cut to desired lengths, and one or more holes can be punched through webs thereof, and an upper surface thereof can be shaped and/or textured.

The screed elements can then be cured, which depending on the material choice can include rapid curing treatments such as steam treatment, for example.

### BRIEF DESCRIPTION OF THE DRAWINGS

FIGS., 1, 2 and 3 are end, partial side, and isometric views of a representative embodiment of a screed strip made in accordance with the present disclosure.

FIGS. 4-5 illustrate an exemplary embodiment of a method in accordance with the present disclosure.

FIGS. 6-13 illustrate various alternative embodiments in accordance with the present disclosure.

### DETAILED DESCRIPTION OF PREFERRED EMBODIMENTS

FIG. 1 is a cross-sectional view of an exemplary screed element 1 constructed in accordance with one embodiment of the present disclosure. Surface features 2 can be provided in the upper surface 4 of the screed element to mimic the desired surface and/or to limit any cracking that may occur during service of the screed element 1.

As mentioned above, one or more apertures or holes 3 can be provided in a center portion of the screed element 1. As illustrated, the screed element is substantially I-shaped in cross section so as to reduce material use and weight of the screed element 1.

The holes 3, in accordance with one aspect, are preferably spaced at regular intervals, for example at distances of two, four, six, eight, or twelve inches on center, or as otherwise desired. The holes 3, can be about ½″ to about 1″ in diameter or larger as desired or required. The holes 3 can be used for insertion of reinforcing bars, fasteners and/or as a weakened region for facilitating field -cutting with hammer and chisel, masonry saw or paver cutter, for example. Reference number 5 indicates regions where reinforcement elements and/or attachment elements for mutually attaching adjacent screed elements 1 can be provided therein. Continuous extruded voids and/or depressions can be formed within the screed elements 1. Such features can be formed during extrusion or after cutting to length, as desired or required. For purposes of illustration and not limitation, an exemplary height 14 of the screed element 1, as mentioned above may be between about 2 and 12 inches, and in a preferred embodiment may be about four inches. A width 15 of the screed element 1 can be any desired width, but in accordance with a preferred embodiment is preferably about 1 to 6 inches, more preferably about 2 to 4 inches, and in accordance with one example about 2 inches.

FIG. 2 is a side view of the screed element 1 of the present invention, wherein one or more depressions 6 are formed into the top and/or bottom surfaces of the screed element 1, and are spaced along the length of the screed element 1 by a distance of about eight inches. Other distances between the depressions 6 may be used, as desired, such as to facilitate matching of a pattern to be formed on surrounding concrete, such as a brick pattern, tile pattern, stone or other pattern.

FIG. 3 is an isometric view of the screed element 1 in accordance with the invention. The length 16 of the screed element can be any desired length. In accordance with exemplary embodiments of the invention, the length is preferably between about four (1.3 meters) and eight feet (2.6 meters), and in accordance with one embodiment is preferably about 6 feet (2 meters). In accordance with the invention, the screed element 1 can be provided in a variety of lengths and shapes (e.g., curved or cross-shaped or as a curb segment if bordering a road or other change in elevation) to facilitate various arrangements and designs. In accordance with one embodiment of the invention, the weight of the screed element preferably does not exceed a safe carrying weight, which can be determined by mason's labor policies or a ruling OSHA regulation for example. This of course is not to suggest that the invention cannot be embodied in a much larger format that must be carried by machine.

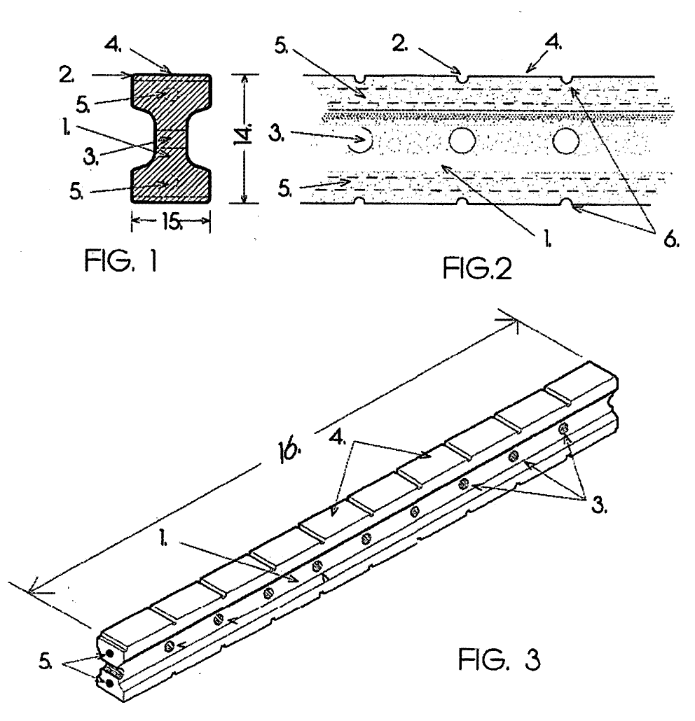

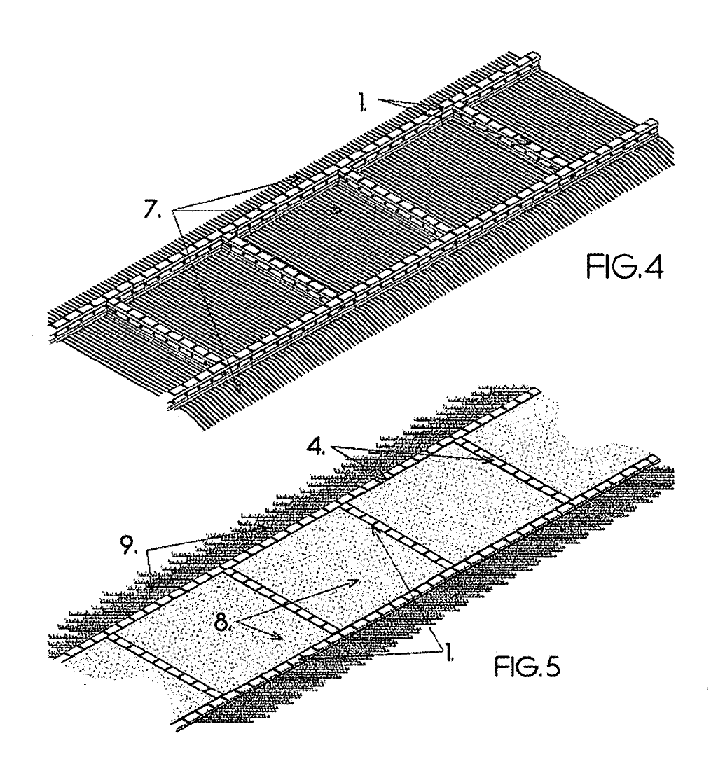

FIG. 4 illustrates an exemplary system including multiple screed elements 1 assembled over a bed 7, which can be formed of porous stone or sand, for example. FIG. 5 illustrates the same portion of sidewalk with the concrete 8 poured, and the surrounding regions backfilled with earth 9, for example.

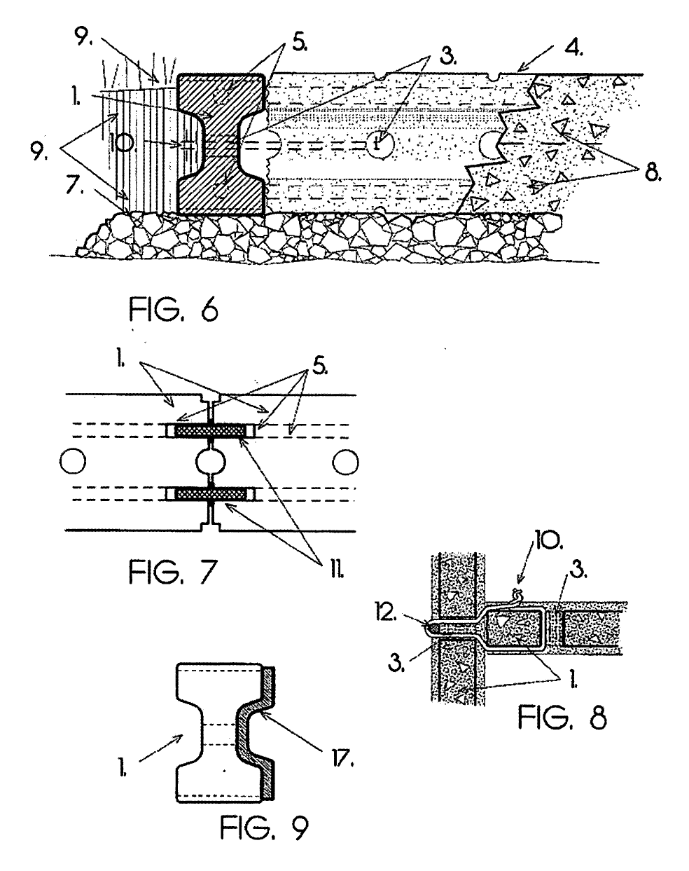

FIG. 6 is a sectional view, illustrating a portion of the subject system installed in accordance with the invention, where two screed elements 1 meet at an intersection and are mutually tied together with a tie attachment 10. The screed element 1 is shown installed over the porous base layer 7, and poured concrete region 8 is provided, with backfill being indicated by reference number 9.

FIG. 7 details an end-to-end attachment of screed elements 1, and alignment thereof utilizing pins 11 inserted into the ends of the screed elements 1. The screed elements 1 can be further mutually attached by a wire tie or other element.

FIG. 8 details an end-to-side attachment of two screed elements 1. The ties 10 can be formed of bendable tying wire pulled through holes 3 formed in the screed elements 1, as illustrated. In an end-to-side arrangement can be looped around a pin 12 and twisted until tight, for example.

FIG. 9 illustrates a concrete screed strip 1 including an integral expansion element 17 formed on one side thereof. The expansion element 17 can be any suitable material such as an elastomeric material, bituminous material or the like. The expansion strip 17 is preferably about ½″ in thickness and is installed about every twenty feet along a poured slab formed with the systems in accordance with the invention, to allow for expansion in hot weather.

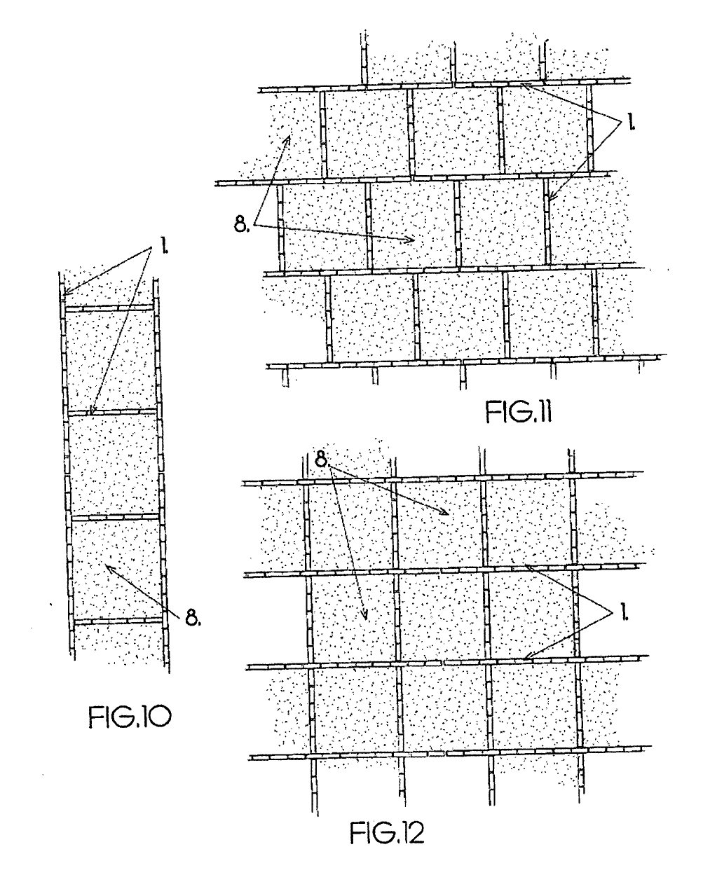

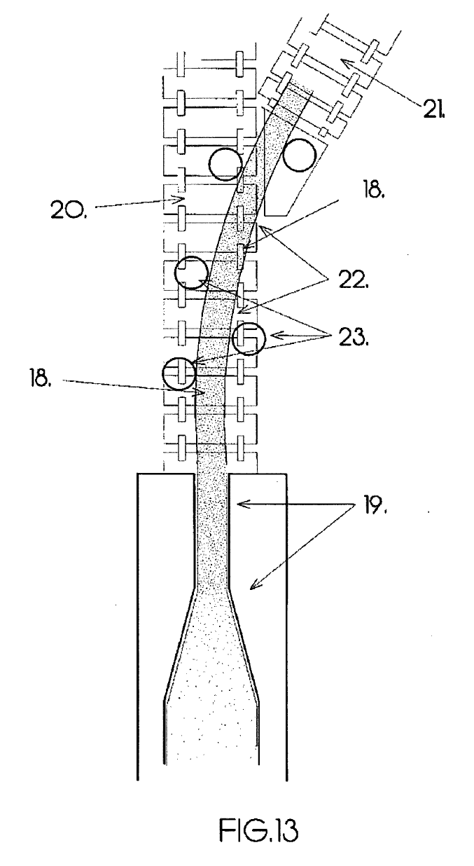

FIGS. 10, 11 and 12 illustrate pavement configurations in accordance with the invention that can be formed with screed strips 1 of the subject systems.

If desired, as mentioned above, curvature of the screed elements 1 can be imparted thereto before curing thereof. Standard, popular curvatures can be provided, or curvatures can be special ordered by a customer, such as, for example a 30 foot (10 meter) radius or 50 foot (16 meter) radius among others, such as a one foot radius such as for a corner portion, or a two, three, four, five, six, eight, ten, fifteen or twenty foot radius, for example.

The systems and elements of the invention can alternatively be used as curbing, boundary edging for pavement areas of loose pavers made of concrete, stone, brick or asphalt, and can be used for edging for planting beds and/or as permanent pavement markings in vehicular paved areas such as lane markings, one way arrows and cross walks. The subject screed elements can also be integrally formed with a gutter element or other edging feature.

Advantageously, the subject system can be self-supporting, with adjacent screed elements supporting one another. If desired, lines of weakness can be preformed in the subject screed elements to facilitate on-site sizing thereof. If desired, tabs can be formed into longitudinal ends of the screed elements 1 to facilitate engagement with ends and/or sides of other screed elements 1. Additional features can also be included into the devices and systems in accordance with the invention, including use of reflective materials or surface treatments for use as lane markings, cross-walks or the like, or integrally formed reflectors or sockets for accepting reflectors, for example. It will be further appreciated by those of skill in the art that the screed system may have any suitable cross section in addition to the depicted “I”-shaped cross section. For example, screed elements having rectangular, L-shaped, T-shaped, rounded, triangular, stepped, tapered or any other suitably-shaped cross-section may be used.

In accordance with still a further embodiment, FIG. 13 depicts a concrete extruding machine in plan view. The extruding machine 19 normally utilized a roller or other conveyor 20 for output of a straight screed strip. As illustrated, an auxiliary conveyor 21 is provided that carries the output of a curved screed strip. Extruded concrete strips 18 are gently curved by an operator as the extrudate exits a die of predetermined configuration to permit formation of a screed strip 18 with a desired cross-sectional profile. The extrudate is thus slightly damp and flexible, and once formed and cut into predetermined lengths can be air cured and/or steam cured. Overhead suspended rollers 23 may be used to assist an operator in obtaining and/or maintaining a desired radius of curvature.

The methods and systems of the present invention, as described above and shown in the drawings, provide for a screed system with superior properties to those of the prior art. It will be apparent to those skilled in the art that various modifications and variations can be made in the device and method of the present disclosure without departing from the spirit or scope of the invention. Thus, it is intended that the present invention include modifications and variations that are within the scope of the subject disclosure and equivalents.

1. A screed strip comprising an elongate body having a top surface, wherein the top surface includes a decorative pattern defined thereon.

2. The screed strip of claim 1, wherein the decorative pattern is formed by real brick, real stone, or real tile.

3. The screed strip of claim 1, wherein the decorative pattern is formed by imitation brick, imitation stone, or imitation tile.

4. The screed strip of claim 1, wherein the screed strip has a height between about 2 inches and about 12 inches.

5. The screed strip of claim 4, wherein the screed strip has a height between about 6 inches and about 8 inches.

6. The screed strip of claim 1, wherein the screed strip includes material selected from the group consisting of concrete, colored concrete, ceramic, aggregate, asphalt and clay.

7. The screed strip of claim 1, wherein the screed strip includes material selected from the group consisting of plastic, composite and fiber-reinforced materials.

8. The screed strip of claim 1, wherein the screed strip includes recycled material selected from the group consisting of recycled glass, recycled polypropylene, recycled polyethylene terephthalate (“PET”), recycled aggregate in a cementitious matrix and recycled asphalt-based materials.

9. The screed strip of claim 1, wherein the screed strip is curved.

10. A system, comprising;
a) a plurality of screed strips arranged in a predetermined pattern, each screed strip including at least one aperture proximate an end thereof;
b) a tie attaching two of the screed strips together at an intersection of the screed strips.

11. The system of claim 10, wherein at least one of the screed strips comprises an elongate body having a top surface, wherein the top surface includes a decorative pattern defined thereon.

12. The system of claim 11, wherein the decorative pattern is formed by real brick, real stone, or real tile.

13. The system of claim 11, wherein the decorative pattern is formed by imitation brick, imitation stone, or imitation tile.

14. The system of claim 10, wherein at least one of the screed strips includes material selected from the group consisting of concrete, colored concrete, ceramic, aggregate, asphalt and clay.

15. The system of claim 10, wherein at least one of the screed strips includes material selected from the group consisting of plastic, composite and fiber-reinforced materials.

16. The system of claim 10, wherein at least one of the screed strips includes recycled material selected from the group consisting of recycled glass, recycled polypropylene, recycled polyethylene terephthalate (“PET”), recycled aggregate in a cementitious matrix and recycled asphalt-based materials.

17. The system of claim 10, wherein at least one of the screed strips is curved.

18. A method for forming a screed strip, comprising extruding a material through a die having a predetermined profile to form a screed strip having a desired cross-sectional profile, wherein the extruded strip is curved into a desired radius of curvature after exiting the die.

19. The method of claim 18, wherein the extrudate includes material selected from the group consisting of concrete, colored concrete, ceramic, aggregate, asphalt and clay.

20. The method of claim 18, wherein the extrudate includes material selected from the group consisting of plastic, composite, fiber-reinforced materials, recycled glass, recycled polypropylene, recycled polyethylene terephthalate (“PET”), recycled aggregate in a cementitious matrix and recycled asphalt-based materials.
